(19) United States
(12) Patent Application Publication
(10) Pub. No.: US 2025/0164060 A1
(43) Pub. Date: May 22, 2025

(54) POSITIONING PROTECTION DEVICE FOR A CABLE OF A CRANE MACHINE

(71) Applicant: PAOKAI ELECTRONIC ENTERPRISE CO., LTD., Kaohsiung City (TW)

(72) Inventors: Ming-Shan Wei, Kaohsiung City (TW); Tung-Ying Wei, Kaohsiung City (TW)

(73) Assignee: PAOKAI ELECTRONIC ENTERPRISE CO., LTD., Kaohsiung City (TW)

(21) Appl. No.: 18/413,757

(22) Filed: Jan. 16, 2024

(30) Foreign Application Priority Data
Nov. 22, 2023 (TW) 112212700

(51) Int. Cl. F16L 57/06

(52) U.S. Cl. CPC F16L 57/06

(57) ABSTRACT

A positioning protection device includes a tubular body defining an accommodating space that is adapted for the cable to extend therethrough, a plurality of flanges disposed on an outer surface of the tubular body and spaced apart from each other along an axial direction of the tubular body, and an end fastener disposed on an end of the tubular body and adjacent to one of the flanges. The end fastener and the one of the flanges are adapted to be positioned respectively on two opposite sides of the hole wall.

### CROSS-REFERENCE TO RELATED APPLICATION

This application claims priority to Taiwanese Utility Model patent application No. 112212700, filed on Nov. 22, 2023, the entire disclosure of which is incorporated by reference herein.

### FIELD

The disclosure relates to a positioning protection device, and more particularly to a positioning protection device for a cable of a crane machine.

### BACKGROUND

Referring to FIG. 1, a conventional crane machine includes a clamping jaw (not shown), a sleeve 20, a tube 11, a cable 12, and a cable protective positioning structure 10. The cable protective positioning structure 10 is adapted to be installed on the sleeve 20 of the conventional crane machine. The sleeve 20 defines a mounting space 200 for mounting the tube 11, and is formed with a recess 201 that extends radially therethrough and that is in spatial communication with the mounting space 200. The tube 11 is configured to allow the cable 12 to pass therethrough. The cable protective positioning structure 10 is disposed in the recess 201, and defines a socket hole 100 through which the cable 12 extends. By virtue of the cable protective positioning structure 10, friction between the cable 12 and physical structure around the recess 201 may be avoided, thereby preventing abnormalities such as a short circuit or an open circuit caused by abrasion from occurring, so that the clamping jaw of the crane machine may be ensured to operate properly.

However, ways of playing the crane machine are increasingly greater. Various different ways of playing the crane machine by skilled players may cause the clamping jaw of the crane machine to shake severely while in operation. The cable protective positioning structure 10 is disposed at a location of the recess 201, and a protection range of the cable protective positioning structure 10 only covers a surrounded portion of the cable 12 surrounded by the cable protective positioning structure 10 at the location of the recess 201. Hence, if an outer portion of the cable 12 that extends outside the socket hole 100 is bent, a junction between the surrounded portion and the outer portion of the cable 12 may be bent to a relatively large angle. Under long-term operation, it is difficult to ensure that the cable 12 may not be worn out, and thus an optimized solution needs to be provided.

### SUMMARY

Therefore, an object of the disclosure is to provide a positioning protection device for a cable of a crane machine that can alleviate the drawback of the prior art.

According to the disclosure, the positioning protection device is adapted to be mounted to a sleeve of the crane machine and for protecting the cable of the crane machine. The sleeve includes a body that defines an inner space for accommodating a portion of the cable. The body has a hole wall that defines a hole extending through the body and adapted for the cable to pass therethrough. The positioning protection device is adapted to be mounted to the hole, and includes a tubular body defining an accommodating space that is adapted for the cable to extend therethrough, a plurality of flanges disposed on an outer surface of the tubular body and spaced apart from each other along an axial direction of the tubular body, and an end fastener disposed on an end of the tubular body and adjacent to one of the flanges. The end fastener and the one of the flanges are adapted to be positioned respectively on two opposite sides of the hole wall relative to the sleeve.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view illustrating a conventional cable protective positioning structure of a crane machine.

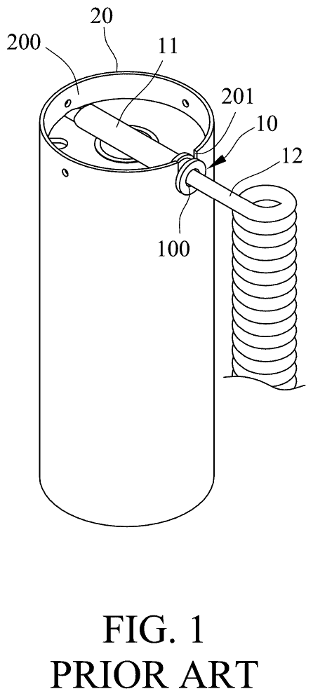

FIG. 2 is a fragmentary partially-exploded perspective view illustrating a first embodiment of a positioning protection device for a cable of a crane machine according to the present disclosure.

FIG. 3 is a perspective view illustrating that the first embodiment is mounted to a sleeve of the crane machine.

FIG. 4 is a schematic side view illustrating relative positions between a plurality of flanges and an end fastener of the first embodiment.

FIG. 5 is a schematic view illustrating the first embodiment in a bent state when an external force is applied thereto.

FIG. 6 is a schematic side view illustrating a second embodiment of the positioning protection device according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

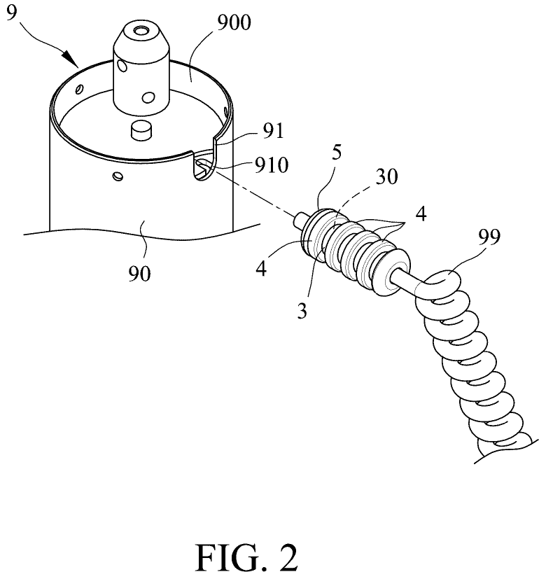

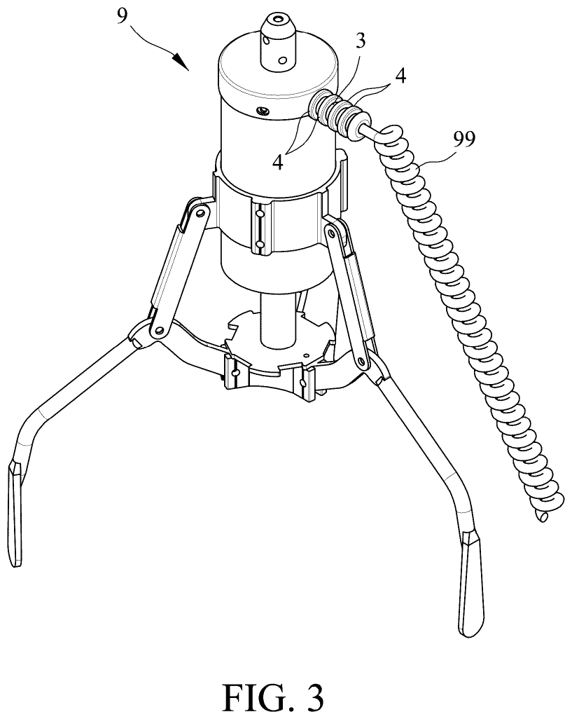

Referring to FIGS. 2 and 3, a first embodiment of a positioning protection device for a cable of a crane machine according to the present disclosure is adapted to be mounted to a sleeve 9 of the crane machine. The crane machine includes the sleeve 9 and a cable 99. The sleeve 9 includes a body 90 defining an inner space 900 for accommodating a portion of the cable 99. The body 90 has a hole wall 91 defining a hole 910 that extends through the body 90 and that is adapted for the cable 99 to pass therethrough. The first embodiment of the positioning protection device is made of an elastic material, and is mounted to the hole 910. The elastic material may be silicone rubber, latex, rubber, or any combination thereof. The positioning protection device includes a tubular body 3 defining an accommodating space 30 that is adapted for the cable 99 to extend therethrough, a plurality of flanges 4 (e.g., four flanges 4 in the first embodiment) disposed on an outer surface of the tubular body 3 and spaced apart from each other along an axial direction of the tubular body 3, and an end fastener 5 disposed on an end of the tubular body 3 and adjacent to one of the flanges 4. The end fastener 5 and the adjacent flange 4 are adapted to be positioned respectively on two opposite sides of the hole wall 91 relative to the sleeve 9.

It should be noted that in the present embodiment, the cable 99 is exemplified in a spirally-extending form similar to a phone line. Hence, the cable 99 is suitably bendable and may be stretched in its own axial direction. As such, a clamping jaw or claw of the crane machine may be moved faster and more agilely within a greater range in response to various ways of playing the crane machine by the players. However, in actual implementation, the cable 99 that cooperates with the first embodiment is not limited to be only in the spirally-extending form.

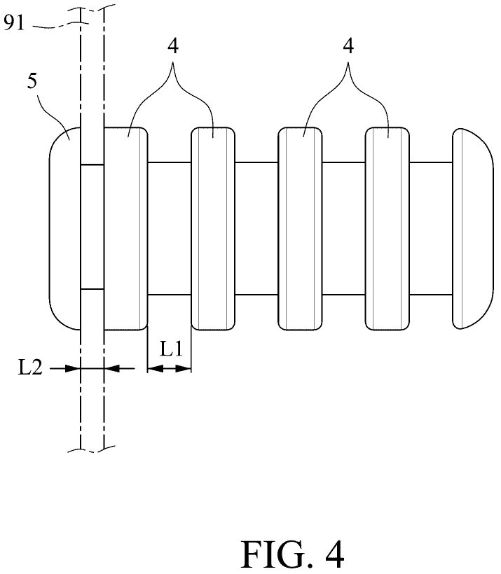

Referring to FIGS. 2 and 4, a distance between two adjacent ones of the flanges 4 is defined as a first length (L1), and a distance between the end fastener 5 and the adjacent flange 4 is defined as a second length (L2). The second length (L2) is approximately equal to a thickness of the hole wall 91 of the body 90 of the sleeve 9. As such, when the first embodiment is installed, by virtue of the second length (L2), the end fastener 5 is disposed in the inner space 900, and the adjacent flange 4 abuts against an outer side of the hole wall 91. Since the end fastener 5 and the adjacent flange 4 are fixed respectively to two opposite sides of the hole wall 91, the first embodiment is mounted stably on the sleeve 9. It is worth mentioning that, in practice of this disclosure, the first length (L1) may not be shorter than the second length (L2). In the first embodiment, the first length (L1) is designed to be greater than the second length (L2), so that when the first embodiment is being mounted, a wrong mounting method, in which an operator clamps the hole wall 91 by two of the flanges 4 that are adjacent to each other to the opposite sides of the hole wall 91, may be avoided, thereby establishing an effective and foolproof installation mechanism.

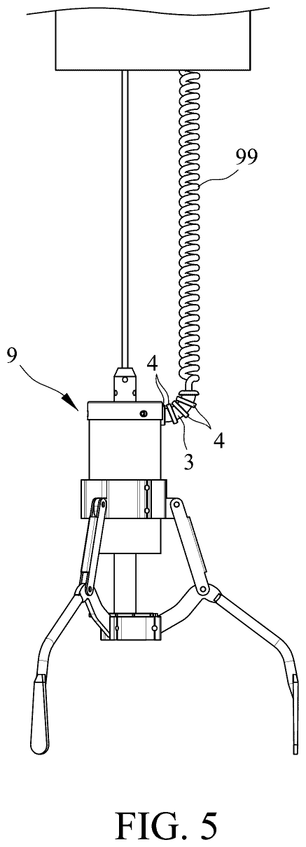

Referring to FIGS. 2, 3 and 5, the crane machine to which the first embodiment is installed utilizes the tubular body 3 that has a length (i.e., an extending length) extending from the outer side of the sleeve 9 to protect a relatively long portion of the cable 99 when the cable 99 extends through the accommodating space 30 of the tubular body 3. Furthermore, since the flanges 4 may serve as a reinforcing structure for the tubular body 3, when the tubular body 3 is bent as shown in FIG. 5, the reinforcing structure may suitably limit the tubular body 3 to prevent the tubular body 3 from being excessively bent. Therefore, a bending degree of the portion of the cable 99 that extends through the tubular body 3 may be limited, thereby preventing the cable 99 from being damaged due to excessive bending for a long period of time.

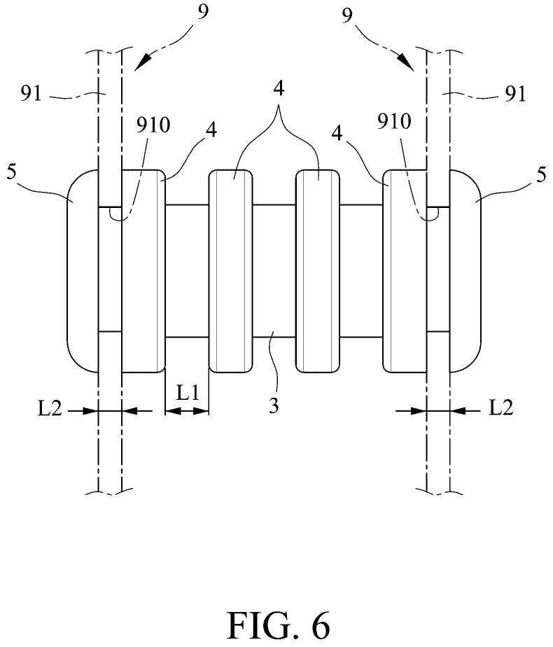

Referring to FIG. 6, a second embodiment of the positioning protection device for a cable of a crane machine according to the present disclosure differs from the first embodiment in that the second embodiment further includes an end fastener 5 disposed on another end of the tubular body 3. That is to say, the second embodiment includes two end fasteners 5. The end fasteners 5 are disposed respectively on the opposite ends of the tubular body 3. Each of the end fasteners 5 is adjacent to one of the flanges 4, and is able to cooperate with the adjacent flange 4 to clamp the hole wall 91 so as to position the tubular body 3 relative to the sleeve 9. Thus, when the second embodiment is mounted, any one of the end fasteners 5 may be smoothly mounted to the sleeve 9. In other words, when the second embodiment is installed and replaced, the orientation of the positioning protection device does not need to be considered, so that the efficiency of installing and replacing the crane machine may be significantly improved. In addition, the second embodiment may achieve the same effect of protecting the cable 99 (shown in FIG. 3) as the first embodiment.

In summary, the positioning protection device for a cable of a crane machine of this disclosure may be conveniently mounted to the sleeve 9. Due to the reinforcing structure of the tubular body 3 that includes the flanges 4, the cable 99 may be protected by the tubular body 3. Meanwhile, by the reinforcing structure of the flanges 4, an extent of an angle to which the cable 99 may be bent is reduced, thereby achieving protection for the cable 99 so that normal operation of the crane machine may be ensured. Therefore, the object of the present disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A positioning protection device adapted to be mounted to a sleeve of a crane machine and for protecting a cable of the crane machine, the sleeve including a body that defines an inner space for accommodating a portion of the cable, the body having a hole wall that defines a hole extending through the body and adapted for the cable to pass therethrough, said positioning protection device being adapted to be mounted to the hole, and comprising:
a tubular body defining an accommodating space that is adapted for the cable to extend therethrough;
a plurality of flanges disposed on an outer surface of said tubular body and spaced apart from each other along an axial direction of said tubular body; and
an end fastener disposed on an end of said tubular body and adjacent to one of said flanges, said end fastener and the one of said flanges being adapted to be positioned respectively on two opposite sides of the hole wall relative to the sleeve.

2. The positioning protection device as claimed in claim 1, further comprising an additional end fastener disposed on another end of said tubular body.

3. The positioning protection device as claimed in claim 1, wherein a distance between two adjacent ones of said flanges is defined as a first length, a distance between said end fastener and the one of said flanges is defined as a second length, and the first length is not shorter than the second length.

4. The positioning protection device as claimed in claim 1, wherein a quantity of said flanges is four.

5. The positioning protection device as claimed in claim 1, wherein said positioning protection device is made of an elastic material.
